(19) United States
(12) Patent Application Publication
(10) Pub. No.: US 2023/0010708 A1
(43) Pub. Date: Jan. 12, 2023

(54) METHOD FOR PRODUCING A HOUSING OF AN AIR CONDITIONER

(71) Applicant: MAHLE International GmbH, Stuttgart (DE)

(72) Inventors: Jesus MARTINEZ PODEROS, Zaragoza (ES); Jochen SCHAUDT, Hechingen (DE); Bernd BARTENBACH, Talheim (DE); Franz SPOERL, Pfoerring (DE); Ralf BERNDT, Ditzingen-Schoeckingen (DE); Bernd KROLL, Freiberg (DE)

(73) Assignee: MAHLE International GmbH, Stuttgart (DE)

(21) Appl. No.: 17/861,621

(22) Filed: Jul. 11, 2022

(30) Foreign Application Priority Data
Jul. 12, 2021 (DE) 10 2021 207 379.4

(51) Int. Cl. B29C 45/14

(52) U.S. Cl. CPC B29C 45/14467; B29C 45/14008; B29K 2995/0091; B29K 2105/20

(57) ABSTRACT

A method for producing a housing of an air conditioner, in which at least a part of the housing is produced as a plastic part by means of an injection molding process by injecting a plastic into a mold cavity of an injection molding tool, wherein a damping element is placed in the injection mold prior to injection of the plastic into the injection mold so that the damping element establishes a bond with the plastic during injection of the plastic into the injection mold and becomes a component of the injection-molded plastic part.

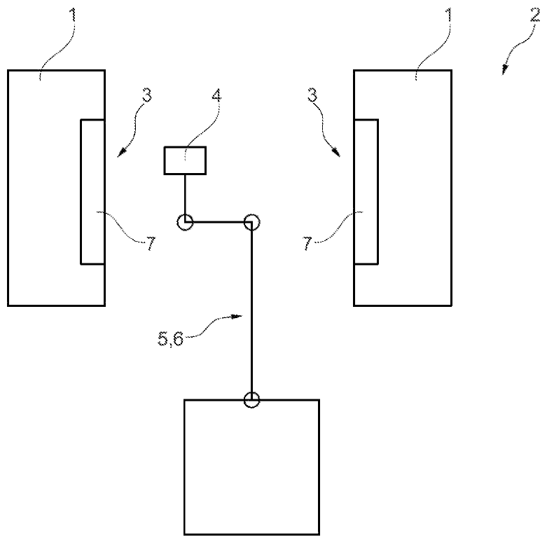

This nonprovisional application claims priority under 35 U.S.C. § 119(a) to German Patent Application No. 10 2021 207 379.4, which was filed in Germany on Jul. 12, 2021, and which is herein incorporated by reference.

### BACKGROUND OF THE INVENTION

### Field of the Invention

The present invention relates to a method for producing a housing of an air conditioner, in particular an air conditioner of a motor vehicle.

### Description of the Background Art

Air conditioners of motor vehicles have a plastic housing with air ducts, and filters, valves, and heat exchangers arranged therein. In addition, a blower is provided that is designed with a blower motor and an impeller, wherein the blower motor drives the impeller in order to create a flow of air through the air ducts of the housing of the air conditioner. The blower motor is held in a retaining frame that supports the blower in the housing of the air conditioner.

During operation of the blower, the rotating impeller creates the desired flow of air, wherein noises are also simultaneously produced that are conducted into the passenger compartment of the motor vehicle, where they may be considered bothersome.

In order to suppress such bothersome noises, felt strips are manually affixed to the retaining frame and to the plastic housing of the air conditioner, for example, in order firstly to suppress the structure-borne propagation of the noise, and also to suppress the transmission of the noise through the air.

For this purpose, on the one hand the felt strip is placed on, e.g., the retaining frame of the blower motor in such a manner that it is located between the retaining frame and the blower motor and suppresses the transmission of the vibration of the blower motor to the retaining frame and thus to the housing of the air conditioner.

It is also known for such felt strips to be placed on the inner sides of the walls of the air conditioner housing in order to suppress the propagation of the sound of the bothersome noise through a suppression of the vibration of the wall of the air conditioner housing.

For this purpose, the felt strips are manually inserted or affixed with adhesive at predefined locations in the assembly of the air conditioner, which leads to increased assembly effort and to an increased number of assembly errors, for example because the felt strip is placed with too little adhesive and detaches again or that the felt strip is affixed at an incorrect location.

### SUMMARY OF THE INVENTION

It is therefore an object of the present invention to provide a method for producing a housing of an air conditioner that achieves an improvement over the prior art and simultaneously allows more economical manufacture.

An exemplary embodiment of the invention relates to a method for producing a housing of an air conditioner, in which at least a part of the housing is produced as a plastic part by means of an injection molding process by injecting a plastic into a mold cavity of an injection molding tool, wherein a damping element is placed in the injection mold prior to injection of the plastic into the injection mold, so that the damping element establishes a bond, for example a mechanical bond and/or a microserration, with the plastic during injection of the plastic into the injection mold and becomes a component of the injection-molded plastic part. As a result, manual placement of damping elements after production of the plastic part is avoided, and thus also the associated problems and errors, wherein assembly time and assembly costs are also reduced as a result.

The purpose of the suppression can be vibration/structure-borne sound as well as acoustics/airborne sound.

It is especially advantageous in this regard when the damping element is a textile damping element. This can then be integrated in the plastic wall or in the plastic part or placed on the plastic wall or on the plastic part, so that it is no longer necessary to manually populate the plastic part, wherein the textile damping element exhibits the desired vibration-damping and/or sound-insulating properties. Moreover, the textile material is well suited for use in an injection molding process because it does not degenerate at the high temperatures of the injected plastic.

It is also advantageous when the textile damping element is a textile felt element or nonwoven element or a foam element, in particular is a textile felt or nonwoven strip or a foam strip. In this way, it is also achieved that the desired vibration-damping and/or sound-insulating properties are present. The material used is also well suited structurally for use in the injection molding process.

It is also advantageous when the felt, nonwoven, and/or foam element is made of a plastic, as for example polyurethane, polyether, polyester, or of cotton, rubber, and/or of synthetic foams. In this way, it is also achieved that the desired vibration-damping and/or sound-insulating properties are present, and the material used is well suited for use in the injection molding process because it does not degenerate at the high temperatures of the injected plastic.

It is especially advantageous when the placement of the damping element in the mold cavity of the injection molding tool is accomplished in automated fashion. As a result, very high positioning quality is achieved so that the error rate in placement virtually vanishes, which represents a distinct improvement over manual positioning on the finished plastic part.

It is also useful when the placement of the damping element in the mold cavity of the injection molding tool is accomplished by means of an automated manipulator or by means of a robot. As a result, the damping element can be placed rapidly and in the correct position.

It is advantageous as well when, during the automated placement of the damping element, multiple damping elements are placed simultaneously in the injection mold and/or in the injection molding tool and/or that the placement of damping elements is carried out serially in an injection mold and/or an injection molding tool. It is thus also possible for multiple damping elements to be placed simultaneously. In addition, multiple damping elements can be placed one after the other in rapid succession.

In addition, it is useful when the bond is a chemical, integral bond between the damping element and the plastic material. In this way, it is optionally also possible to dispense with additional adhesives.

In addition, it is useful when the part of the housing is or has a wall part of the housing and/or is or has a flap and/or is or has a retaining frame, etc.

Advantageous improvements of the present invention are described in the dependent claims and in the figure description below.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole figure is a schematic view of an injection molding tool of an injection molding device for the purpose of explaining the method according to the invention.

### DETAILED DESCRIPTION

In a schematic representation, the figure shows an injection molding tool 1 of an injection molding device 2 for the purpose of explaining a method according to the invention for producing a housing 3 of an air conditioner.

In this case, the housing 3 is composed of at least one part that is produced as a plastic part by means of an injection molding process by injecting a plastic into a mold cavity 7 of an injection molding tool 1.

According to the invention here, a damping element 4 is placed in the mold cavity 7 of the injection molding tool 1 prior to injection of the plastic into the mold cavity 7 of the injection molding tool 1, so that the damping element 4 establishes a bond with the plastic during injection of the plastic into the injection mold 7 of the injection molding tool 1 and becomes a component of the injection-molded plastic part.

Especially advantageously, the damping element 4 is a textile damping element. In this case, the textile damping element 4 can be a textile felt element or nonwoven element, and/or a foam element, in particular a felt, nonwoven, and/or foam strip.

Preferably, the textile felt, nonwoven, and/or foam element is made of a plastic, as for example of a polyurethane, polyether, polyester, or of cotton, rubber, and/or of synthetic foams.

The placement of the damping element 4 in the mold cavity 7 of the injection molding tool 1 is accomplished in an automated fashion.

Advantageously, the placement of the damping element 4 in the mold cavity 7 of the injection molding tool 1 is accomplished by means of an automated manipulator 5 or by means of a robot 6.

During the automated placement of the damping element 4, it is also possible that multiple damping elements 4 are simultaneously placed in the mold cavity 7 and/or in the injection molding tool 1 and/or that the placement of damping elements 4 is carried out serially in the mold cavity 7 and/or in the injection molding tool 1.

In this case, the bond is a mechanical or chemical bond between the damping element and the plastic material.

Preferably, the part of the housing is a wall part of the housing or it has such a wall part and/or it is a flap or it has such a flap and/or it is a retaining frame or it has such a retaining frame, etc.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a housing of an air conditioner in which at least a part of the housing is produced as a plastic part via an injection molding process, the method comprising:
injecting a plastic into a mold cavity of an injection molding tool; and
placing a damping element in the injection mold prior to injection of the plastic into the injection mold so that the damping element establishes a bond with the plastic during injection of the plastic into the injection mold and becomes a component of the injection-molded plastic part.

2. The method according to claim 1, wherein the damping element is a textile damping element.

3. The method according to claim 2, wherein the textile damping element is a textile felt element, nonwoven element, or a foam element, or is a textile felt, nonwoven, and/or a foam strip.

4. The method according to claim 3, wherein the textile felt element, nonwoven element, and/or foam element is made of a plastic, a polyether, polyester, cotton, rubber, and/or of synthetic foams.

5. The method according to claim 1, wherein the placement of the damping element in the injection mold of the injection molding tool is performed automatically.

6. The method according to claim 1, wherein the placement of the damping element in the mold cavity of the injection molding tool is performed by an automated manipulator or by a robot.

7. The method according to claim 1, wherein, during the automated placement of the damping element, at least two damping elements are substantially simultaneously placed in the injection mold or wherein the placement of damping elements is carried out serially in an injection mold.

8. The method according to claim 1, wherein the bond is a chemical bond between the damping element and the plastic material.

9. The method according to claim 1, wherein the part of the housing is or has a wall part of the housing and/or is or has a flap and/or is or has a retaining frame.
